(19) United States
(12) Patent Application Publication
(10) Pub. No.: US 2026/0349982 A1
(43) Pub. Date: Nov. 5, 2026

(54) IN-DATABASE DATA QUANTIZATION USING CLUSTERING MODELS WITH VERTICAL PARTITIONING

(71) Applicant: Oracle International Corporation, Redwood Shores, CA (US)

(72) Inventors: Boriana Milenova, Reading, MA (US); Xiaolin Wang, Westwood, MA (US); Dongfang Bai, Burlington, MA (US)

(21) Appl. No.: 19/195,244

(22) Filed: Apr. 30, 2025

(51) Int. Cl. G06F 16/22; G06F 16/2453

(52) U.S. Cl. CPC G06F 16/2237; G06F 16/221; G06F 16/24542

(57) ABSTRACT

Here is lossy compression and database task parallelism that save time and space during vector analytics, and this approach does not significantly decrease accuracy of data representation. Multiple database management system (DBMS) processes execute an execution plan. The DBMS processes include access processes generation processes. Each access process vertically slices a respective subset of vectors from a database column into many vector slices and distributes the vector slices to the generation process. During a data shuffle, each generation process receives some vector slices from each access process. From those vector slices, each generation process generates a respective codebook. Multiple codebooks can be concurrently used to cluster, compress, or decompress all vector slices in a same vector. Herein: a codebook is a sequence of multidimensional centroids; a compressed vector slice is a single integer; and a compressed vector is a sequence of fewer numbers than are in an uncompressed numeric vector.

### FIELD OF THE INVENTION

The present invention relates to lossy compression and database task parallelism that save time and space during vector analytics.

### BACKGROUND

The Oracle VECTOR datatype contains a sequence of numbers, and the length of the sequence is application specific. The size of the VECTOR datatype depends on various factors such as follows. Oracle Vector Search supports vectors with up to 65,535 dimensions (i.e. numeric elements). The VECTOR datatype can store elements in primitive number formats, some of which require multiple bytes per number such as a floating-point real number needing four or eight bytes. For example, a vector having 1,024 dimensions in FLOAT32 format occupies 1,024*4 bytes=four kilobytes.

A database column may have a datatype and may store many values of that datatype. How many vectors can be stored in a database column is essentially limited by hardware storage capacity. For example, a database column may store billions of vectors.

In those ways, time and space needed by application-specific analytics of vectors in bulk may be more or less infeasible. For example in some applications, matching a new vector may entail searching through millions of preexisting vectors for a few vectors that are most similar to the new vector. Complexity of vector analytics may increase consumption of space, time, and electricity.

### BRIEF DESCRIPTION OF THE DRAWINGS

In the drawings:

FIG. 1 is a block diagram that depicts an example distributed database management system (DBMS) that saves time and space while generating multiple codebooks from a database column;

FIG. 2 is a flow diagram that depicts an example process that is delegated to multiple access processes and multiple generation processes that generate multiple codebooks from a database column;

FIG. 3 is a block diagram that depicts an example distributed DBMS that saves time and space when generating multiple cluster models and multiple codebooks from a database column;

FIG. 4 is a flow diagram that depicts example codebook activities that a distributed DBMS may perform during the lifecycle of codebooks for a database column;

FIG. 5 depicts an example statement execution plan for parallel compression;

FIG. 6 is a block diagram that illustrates a computer system upon which an embodiment of the invention may be implemented;

FIG. 7 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is lossy compression and database task parallelism that save time and space during vector analytics, and this approach does not significantly decrease accuracy of data representation. This approach entails cluster modeling and multiple codebooks to compress a vector. In addition to application-specific vector analytics, compression herein further entails a clustering model. Herein, the clustering model is a partitioned model, and each partition of the model provides a separate codebook. This partitioning entails vertical slicing of vectors stored in a database column and, for acceleration by horizontal scaling, vertical slices may be concurrently generated or processed.

Each instance of the clustering model operates on a respective disjoint subspace of a multidimensional vector space, referred to as a vertical slice as discussed later herein. In an embodiment, multiple cluster model instances are respectively trained on the individual subspaces in bulk with a single application program interface (API) call. In an embodiment, clustering model centroids are stored in volatile memory or a persistent database for easy access to each subspace. Another single API call allows users to seamlessly drop the partitioned model, which eases maintenance. Using the partition model approach allows for a single data load and efficient data-driven parallelism.

Herein, an original (i.e. uncompressed) numeric vector undergoes extreme compression by dimensionality reduction that may, for example, achieve compression in excess of 500-fold in practical applications. Herein, a clustering model instance consists of multiple multidimensional clusters that each may be identified by the cluster's multidimensional centroid or by an integer identifier of the centroid, and this integer may consist of, for example, as few as four bits. Those four bits may be a lossy encoding of multiple real numbers, and this density is not exceeded by other approaches. Density and space are inversely proportional and, by increasing density (i.e. compression ratio), this approach decreases consumption of volatile or nonvolatile storage space inside a database server or quantitative analytics computer.

Each numeric vector from a database column is a uniform-length sequence (e.g. array) of numbers. Each numeric vector is vertically sliced into adjacent vector slices that are uniform-length subsequences of numbers. Herein, a vector slice is a unit of compression, and this compression is based on a codebook. For horizontally scaled acceleration, all codebooks for a database column may be concurrently operated to cluster, compress, or decompress a respective distinct vertical slice in a same vector.

This approach is noninvasive. For example, a vector analytics database application can be automatically configured to accommodate horizontally-scaled compression of vectors, and this automation requires minimal intervention by a database administrator or data scientist.

A user may be more or less unaware of compression and scaling herein. Structured query language (SQL) can administer and use codebooks to improve database performance as discussed herein.

### 1.0 Example Distributed Database Management System (DBMS)

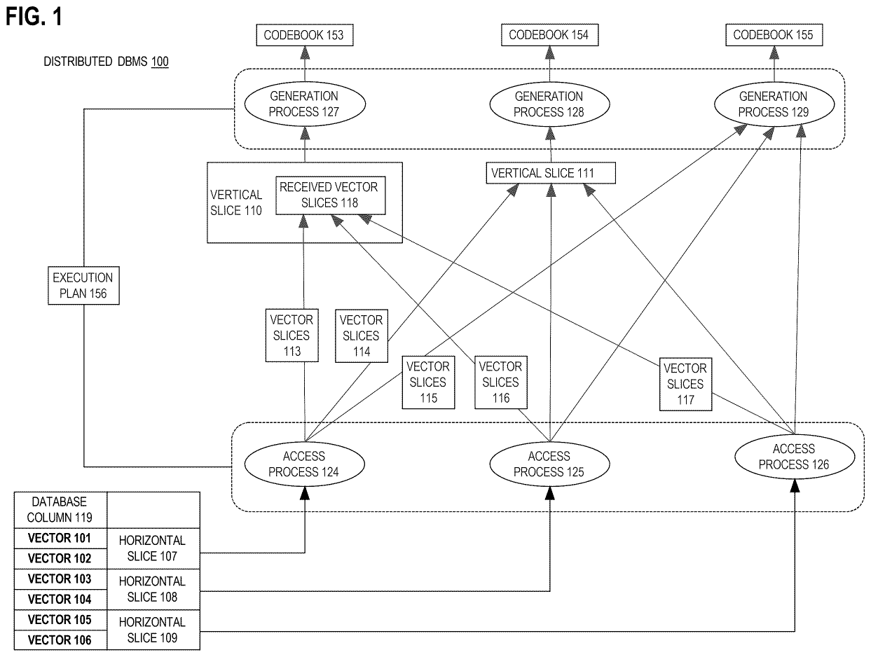

FIG. 1 is a block diagram that depicts an example distributed database management system (DBMS) 100 that saves time and space while generating codebooks 153-155 from database column 119. Distributed DBMS 100 contains and operates DBMS processes 124-129 that may be implemented as execution contexts or threads that independently execute software of distributed DBMS 100. Distributed DBMS 100 may be hosted by one or more computers (not shown) such as a rack server such as a blade, a mainframe, or a virtual computer. All of the components shown in FIG. 1 may be stored and operated in volatile or nonvolatile storage of the computers.

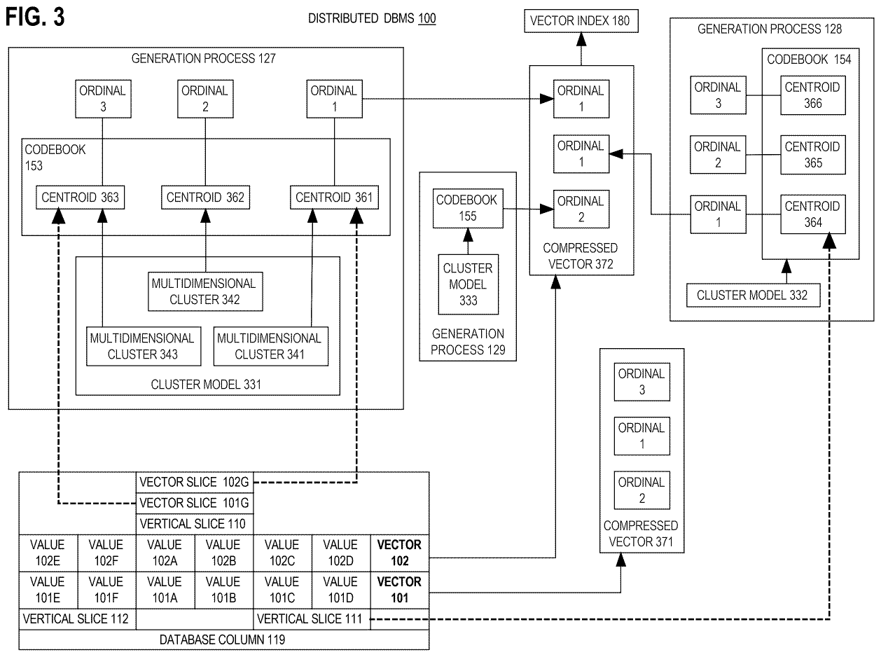

As discussed later herein, DBMS processes 124-129 may cooperatively execute execution plan 156 that may represent a database statement that requests generation of codebooks 153-155, and that generation may entail a data shuffle. As shown, distributed DBMS 100 performs a data shuffle in which vectors 101-106 from database column 119 are vertically sliced into vertical slices 110-111 and, in FIGS. 3, 113. Database column 119 stores many vectors 101-106. Each of vectors 101-106 is a sequence of a same fixed count of numbers (i.e. numeric values).

In the shown embodiment, distributed DBMS 100 assigns each of horizontal slices 107-109 to respective access processes 124-126 for further slicing that is vertical slicing. Each of horizontal slices 107-109 contains multiple vectors. For example, horizontal slice 107 contains vectors 101-102. Horizontal slices 107-109 are logical subsets of vectors from database column 119, which does not mean that database column 119 is physically horizontally partitioned, such as on disk. For example, a database table may contain database column 119, and each of horizontal slices 107-109 may be extracted from a distinct subrange of table rows.

For acceleration, access process 124 may load horizontal slice 107 into volatile memory, including vectors 101-102. Access process 124 performs further slicing by vertically slicing each of vectors 101-102 into three equal-sized vector slices. For example if each of vectors 101-106 contains thirty numbers, and if each vector is vertically sliced into three equal-sized slices then each vector slice contains 30/3=ten numbers. That is, a vector is a sequence of numbers, and each vector slice from that vector is a subsequence of those numbers as discussed later for FIG. 3.

In this example by design, the count of horizontal slices and the count of vertical slices are equal (i.e. three). The nine arrows originating from three access processes 124-126 indicate that vectors 101-106 are vertically sliced into 3×3=nine sets of vector slices as follows. The three arrows originating from access process 124 indicate that vectors 101-102 are one set of vectors that are vertically sliced into three sets of vector slices 113-115 that are respectively sent from access process 124 to respective generation processes 127-129 as follows. Individual vector slices are shown in FIG. 3 as discussed later herein.

The six arrows originating from access processes 125-126 indicate that vectors 103-106 are vertically sliced into six sets of vector slices, including two set shown as vector slices 116-117. Vector slices 116-117 are sent from respective access processes 125-126 to generation process 127. Generation process 127 receives vector slices 113 and 116-117, and these three sets of vertical slices are collectively shown as received vector slices 118 in vertical slice 110. Other generation process 128 receives other vertical slice 111 that includes other sets of vector slices such as vector slices 114.

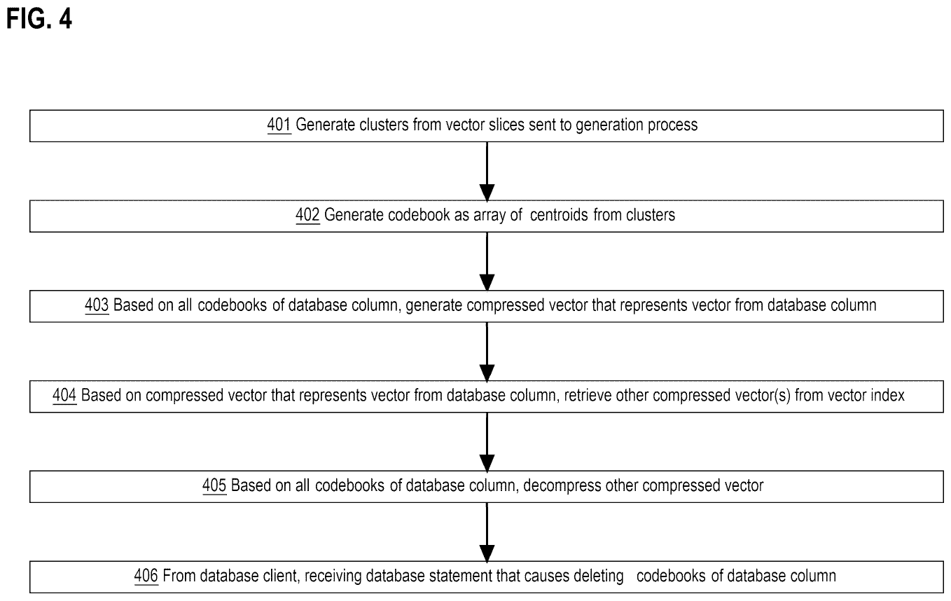

Each of generation processes 127-129 receives a distinct vertical slice of database column 119 and generates a respective one of codebooks 153-155. Each of codebooks 153-155 statistically characterizes a respective one of those vertical slices. For example, codebook 154 statistically characterizes vertical slice 111. Discussed later for FIGS. 3-4 are generation of codebooks 153-155 and database acceleration activities that consult codebooks 153-155.

### 2.0 Example Parallel Generation of Multiple Codebooks

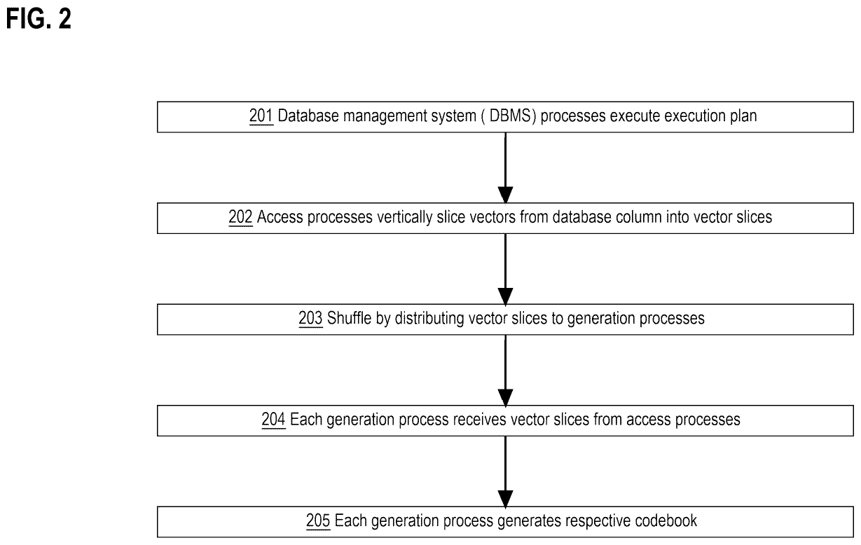

FIG. 2 is a flow diagram that depicts an example process that distributed database management system (DBMS) processes 124-129 may cooperatively perform to save time and space when generating codebooks 153-155 from database column 119. For acceleration, this process uses task parallelism and volatile memory as discussed later herein.

In an embodiment, the process of FIG. 2 is initiated by a data definition language (DDL) statement from a database client, and the process of FIG. 2 may execute that DDL statement. The DDL statement requests generation of codebooks 153-155 from database column 119, which is a particular count of codebooks for a particular database column. In an embodiment, the count of codebooks also is: a count of generation processes 127-129, a count of access processes 124-126, and a degree of horizontally scaled parallelism. In step 201, DBMS processes 124-129 cooperatively execute execution plan 156 that may, for example, represent the DDL statement.

In step 202, access processes 124-126 vertically slice vectors 101-106 from database column 119 into vector slices, including sets of vector slices 113-117. For example in step 202, access process 124 vertically slices vectors 101-102 into 2×3=six vector slices, which is two vector slices in each set of vector slices 113-115. Individual vector slices are shown in FIG. 3 as discussed later herein.

In step 203, access processes 124-126 perform a data shuffle by distributing vector slices to generation processes 127-129. For example in step 203, access process 124 sends vector slices 113-115 respectively to generation processes 127-129. In an embodiment, shuffling by step 203 entails data transmission over an on-chip bus such as when generation processes 124-129 share an address space, and each of generation processes 127-129 executes on a distinct processor core of a central processing unit (CPU). In an embodiment discussed later for FIG. 3 where generation processes 124-129 do not share an address space, shuffling by step 203 entails transmission of data from database column 119 over a communication network such as when each of generation processes 127-129 executes on a distinct network element such as a computer or virtual machine.

In step 204, each of generation processes 127-129 receives some vector slices from access processes 124-126. For example in step 204, generation process 127 receives vertical slice 110 that contains vector slices 113 and 116-117, shown as received vector slices 118. Likewise in step 204, generation process 128 receives vertical slice 111 and, as shown in FIG. 3, generation process 129 receives a third vertical slice 112.

In step 205, each of generation processes 127-129 generates a respective one of codebooks 153-155. In an accelerated embodiment, steps 203-205 and generation processes 127-129 do not access persistent storage and instead read and write data in volatile memory, including vertical slices 110-112. In an embodiment, codebooks 153-155 may also be persisted as metadata into the database that contains database column 119.

### 3.0 Example Codebook Generation from Cluster Model

FIG. 3 is a block diagram that depicts example embodiment of distributed database management system (DBMS) 100 that saves time and space while generating cluster models 331-332 and codebooks 153-155. Distributed DBMS 100 contains generation processes 127-129 that execute the software of distributed DBMS 100. In this embodiment, distributed DBMS 100 contains three computers or virtual machines respectively for three vertical slices 110-112. Each computer contains a respective distinct one of generation processes 127-129 and a respective distinct one of access processes 124-126. For example, DBMS processes 124 and 127 may be in one computer. All of the components shown in FIG. 3 may be stored and operated in volatile or nonvolatile storage of the computers.

### 3.1 Example Database Column

Generation processes 127-129 share and operate a distributed database (not shown) that contains database column 119. As shown in FIGS. 1 and 3, database column 119 contains vectors 101-102. As discussed earlier herein, each of vectors 101-106 consists of a same count of numbers (i.e. numeric values). For example as shown in FIG. 3, vector 101 contains six numeric values 101A-E, and vector 102 contains six numeric values 102A-E.

Vectors 101-106 may each be a one-dimensional array of six numbers that, when vertically sliced into three slices, provides vector slices that each contains 6/3=two numeric values. For example as shown in FIG. 3, vector 101 contains: numeric values 101A-B that are included in vertical slice 110, numeric values 101C-D that are included in vertical slice 111, and numeric values 101E-F that are included in vertical slice 112. Also as shown, vertical slice 110 includes vector slices 101G-102G, where vector slice 101G contains values 101A-B from vector 101, and vector slice 102G contains values 102A-B from vector 102.

Vectors 101-102 are a space-intensive representation that, when used for similarity search or machine learning, may cause various technologic problems such as increased consumption of time, space, and electricity. Compressed vector 372 is a dense encoding (i.e. representation) of vector 102 that saves space and accelerates search and analytics in ways discussed later herein.

For example, each of compressed vectors 371-372 may be used as a lookup key for retrieving similar preexisting vectors from vector index 180 that may be an inverted file index, an inverted file flat vector index, or a hierarchical navigable small worlds (HNSW). Space is saved because vector index 180 stores compressed vectors, not uncompressed vectors. Vector index 180 is accelerated because a compressed vector contains fewer numbers than an uncompressed vector, and a compressed vector contains integers instead of reals. Use of vector index 180 is discussed later herein.

### 3.2 Multidimensional Clustering

Generation of multidimensional clusters 341-343 is as follows. Each of cluster models 331-333 provides a set of multidimensional centroids respectively of a set of multidimensional clusters. Each of codebooks 153-155 represents a respective one of cluster models 331-333. Cluster model 331 and all of its shown components may be generated together and, as discussed later herein, codebook 153 is (e.g. persistently) retained for use after cluster model 331 is discarded. The sole purpose of cluster model 331 is to generate codebook 153.

Even though a vector is a one-dimensional array of multiple numbers, each number may be treated as being in a respective distinct dimension. In that case, a vector may be treated as a multidimensional point in a multidimensional space. Multiple datapoints (i.e. vector slices in a same vertical slice) may be clustered into multiple distinct multidimensional clusters in the multidimensional space as follows.

Herein, K-means clustering is an unsupervised machine learning (ML) algorithm used to group similar vectors together. K-means clustering divides each of vertical slices 110-112 into a predefined count (i.e. K) of multidimensional clusters such that vector slices within a cluster are more similar to each other than to vector slices in other clusters. Initially, all clusters are unpopulated (i.e. almost empty, containing only one vector slice per cluster as discussed later herein).

A multidimensional cluster that, for demonstration, is already populated has exactly one multidimensional centroid, which is calculated as discussed later herein. Herein, a vector or a vector slice may be an array of numbers such as a real or integer, where each number is a value in a respective distinct dimension. For each dimension, a respective arithmetic mean (i.e. average) is calculated from the vector slices in the cluster. During clustering, each of vector slices 101G-102G in vertical slice 110 is added to a respective nearest one of multidimensional clusters 341-343 in cluster model 331. The centroid of the cluster consists of those multiple averages.

### 3.3 Vector Slice is Multicolumn Intersection of Table Row and Vertical Slice

Each of cluster models 331-332 is populated from a respective distinct one of vertical slices 110-111. For example, vector 101 consists of two vector slices respectively in two vertical slices 110-111. For example in vertical slice 110, vector 101 contains a vector slice that consists of values 101A-B. In other words, a vector slice is a multicolumn part of a table row.

Data cells are shown bold in database column 119 to indicate that data cells are actually stored in database column 119. Metadata cells are not shown bold in database column 119 to indicate that metadata cells are implied (i.e. not actually stored in database column 119, e.g. demonstrative or instead stored in a relational schema).

Herein an offset into an array is referred to as an ordinal. Herein, an ordinal is a whole number (i.e. integer that is unsigned). By dimensionality reduction and as shown, vector 102 is represented by compressed vector 372 that is an array of two integers (i.e. ordinal 1 and ordinal 1) even though vector 102 consists of four numeric values. In an example not shown: a) database column 119 consists of vectors that each consists of six numbers, b) each vector slice and each of vertical slices 110-112 consists of three features, and c) for example as shown, compressed vector 372 consists of two features.

### 3.4 Cluster Population

An initial centroid for an empty cluster is not the final centroid of the cluster after population. Clustering herein is incremental, and adding any point (i.e. vector slice) to a cluster increases the accuracy of the centroid of the cluster, which may redefine the centroid of the cluster. This incremental growth of a cluster causes the centroid of the cluster to evolve from an initial centroid as follows to a final centroid as discussed later herein. Herein, each cluster contains its initial centroid as an actual vector slice. For example in vertical slice 111, vector 101 contains vector slice 101G that consists of values 101A-B. Vector slice 101G may be the initial centroid of zero or one of multidimensional clusters 341-343. Each of multidimensional clusters 341-343 is assigned a respective distinct vector slice from vertical slice 111 as a respective initial centroid.

Each of codebooks 153-155 is an array of centroids generated from and representing a distinct respective one of cluster models 331-333. Each of codebooks 153-155 consists of a respective final centroid for each of multiple clusters in the cluster model. For example, codebook 153 represents a three-cluster model that consists of three final centroids 361-363. As follows, a final centroid of a cluster is not an actual vector slice in the cluster.

### 3.5 Centroid Nearest to Vector Slice

After assignment of initial centroids to each of multidimensional clusters 341-343, training of cluster model 331 entails populating of multidimensional clusters 341-343 with all of the vector slices in vertical slice 110 as follows. Each vector slice in vertical slice 110 is added to a respective one of multidimensional clusters 341-343 whose initial centroid is nearest to the vector slice.

Distance between a vector slice and a (e.g. initial or final) centroid is a multidimensional distance such as Euclidian, Manhattan, or Mahalanobis. Herein, distance is a dissimilarity metric. In other words, distance and similarity are inversely correlated. For example, a distance between centroid 361 and any vector slice in vertical slice 110 may be measured by measuring and summing respective differences of numeric values between the vector slice and centroid 361.

Oracle has built-in function VECTOR_DISTANCE that measures multidimensional distance between two VECTORs (e.g. a vector slice and a centroid). Function VECTOR_DISTANCE accepts a parameter that selects a distance metric from predefined (i.e. built in) alternatives such as the following. Euclidean and Euclidean Squared Distances reflect the distance between each of the two vectors' coordinates being compared per the Pythagorean theorem. Cosine Similarity measures the cosine of the angle between two vectors. Dot Product Similarity entails multiplying the size of each vector by the cosine of their angle. Manhattan Distance entails summing the distance between the dimensions of the two vectors. Hamming Similarity is a count of dimensions where two vectors differ.

### 3.6 Compressed Vector

A lifecycle of cluster model 331 may be a sequence of these steps: 1) assignment of initial centroids, 2) population of clusters, 3) calculation of final centroids 361-363 in codebook 153, and 4) retaining codebook 153 after discarding cluster model 331. The sole purpose of the cluster modeling phase is to generate codebooks 153-155. Cluster models 331-333 are generated and discarded during the cluster modeling phase.

Compression does not occur during the cluster modeling phase. Compressed vectors 371-372 are generated as follows. As discussed earlier herein, a (e.g. compressed) vector is a one-dimensional numeric array. In the state of the art, an uncompressed vector consists of real numbers that typically each is an 8-byte value, which may waste space. As discussed below, each of compressed vectors 371-372 instead consists of integers that consume an order of magnitude less space than a real number.

As discussed below, each integer in compressed vectors 371-372 instead represents multiple numbers from a respective vector slice. For example if vertical slice 101G consists of a hundred double-precision real numbers that together can be encoded as a single integer in a single byte, two more orders of magnitude of compression are provided. Thus, integers and vertical slices are two ways of compression that herein are combined to achieve, for example, 1+2=three orders of magnitude of compression as follows.

As discussed earlier herein, vector 101 consists of three vector slices in respective vertical slices 110-112, and those three vector slices are separately encoded (i.e. compressed) using respective codebooks 153-155. Each element in a one-dimensional array (e.g. of centroids) is identified by a distinct offset into the array. An array offset is an unsigned (e.g. zero or, as shown, one based) integer referred to herein as an ordinal. In other words, an ordinal is a whole number or a natural number. Herein, ordinals are dual use. An ordinal may be used as an array offset or as a codebook code or as both.

Each of centroids 361-363 is identified by a respective distinct ordinal. For example as shown, ordinal 2 identifies both of multidimensional cluster 342 and its centroid 362. The ordinal of a centroid is implied by its position (i.e. offset) in the centroid array of a codebook. Ordinals are unique for a given codebook, but not unique across all codebooks 153-155. For example as shown, ordinal 1 identifies both of centroids 361 and 364 in respective codebooks 153-154.

Each of vector slices 101G-102G in vertical slice 110 is encoded (i.e. compressed) as a respective single ordinal, which is the ordinal of one of centroids 361-363 that is nearest to the vector slice, with distance between a vector slice and a centroid measured as discussed earlier herein. A vector slice in vertical slice 111 is encoded as the ordinal of one of centroids 364-366 that is nearest to the vector slice. For example, two vector slices in vector 102 are encoded as ordinal 1, which is why compressed vector 372 consists of ordinal 1 repeated twice, even though both vector slices have different respective nearest centroids 361 and 364.

### 3.7 Configuration and Administration of Compression

A database statement may administer compression in distributed DBMS 100. In an embodiment, the database statement is a structured query language (SQL) statement such as data definition language (DDL). In one scenario, a DDL statement provisions compression. In another scenario, a DDL statement drops (i.e. decommissions) compression. In one scenario, a DDL statement is a single DROP statement that causes deletion of all codebooks 153-155 of database column 119. In an embodiment, a same DROP statement causes deleting both vector index 180 and all codebooks 153-155.

### 4.0 Example Parallel Compression Process

FIG. 4 is a flow diagram that depicts example codebook activities that distributed database management system (DBMS) 100 may perform during the lifecycle of codebooks 153-Docket 155. The processes of FIGS. 2 and 4 may be combined. For example, steps 401-402 may be part of step 205.

Each of generation processes 127-129, in parallel, performs steps 401-402 sequentially. For demonstration, steps 401-402 are discussed for generation process 127 as follows. Step 401 generates multidimensional clusters 341-343, as discussed earlier herein, from received vector slices 118 that consists of sets of vector slices 113 and 116-117 sent to generation process 127.

From multidimensional clusters 341-343, step 402 generates codebook 151 as an array consisting of centroids 361-363 as array elements as discussed earlier herein. All codebooks 153-155 for database column 119 are generated and retained in volatile memory before steps 403-406 that use codebooks 153-155. As discussed earlier herein, a data definition language (DDL) statement could cause steps 401-402 to generate codebooks 153-155. In an embodiment, steps 403-406 that subsequently use codebooks 153-155 may be caused by different database statements or otherwise caused.

Steps 403-405 may be caused by occurrence of an application-specific condition during processing by a database application for an application-specific purpose. For demonstration, steps 403-405 are discussed for vector 102. Based on all codebooks 153-155 of database column 119, step 403 processes vector 102 from database column 119 by generating compressed vector 372 as discussed earlier herein.

Step 404 uses compressed vector 372 as a lookup key to retrieve other compressed vector(s) from vector index 180 as discussed earlier herein. As discussed below, an embodiment of step 404 may operate by decompressing involved compressed vectors, including compressed vector 372. In an embodiment, database column 119 does not contain a compressed vector retrieved from vector index 180. For example, the compressed vector retrieved from vector index 180 may represent a predefined reference vector. Step 404 may be part of a similarity search such as for retrieval augmented generation (RAG). Semantic distance (i.e. dissimilarity) between two uncompressed (or compressed) vectors may be quantitatively measured by, for example, vector index 180. Context, conditions, and distance measurement for a similarity search may be application specific. For example, vector index 180 may return K nearest neighbors (KNN).

In an embodiment, vector index 180 performs steps 404-405, including sequentially: 1) step 404 may select a few more neighbors than will be returned because similarity of lossy compressed vectors is less accurate than similarity of uncompressed vectors, 2) step 405 may be a sub-step of step 404, and step 405 may decompress compressed vector 372 and its selected neighbors using all codebooks 153-155, and 3) after sub-step 405, step 404 may determine what subset of the selected neighbors to return based on more-accurate semantic distance measurements for the uncompressed vectors. Step or sub-step 405 operates as follows.

Based on all codebooks 153-155 of database column 119, step 405 decompresses the compressed vector(s) retrieved by step 404. For example if step 405 were to decompress compressed vector 371: a) using codebook 153, decompression (i.e. decoding) of ordinal 3 returns centroid 363, and b) using codebook 154, decoding of ordinal 1 returns centroid 364. Herein, a centroid provides a decompressed numeric value for each element in a vector slice. As a demonstrative example, vector slice 102G can be more or less accurately regenerated during decompression by copying the numeric values of multidimensional centroid 361 into vector slice 102G. A compressed vector is decompressed by decompressing (i.e. regenerating by decoding) its vector slices, and each of its vector slices is decoded with a distinct respective one of codebooks 153-155, which is the same codebook that was used to compress the vector slice.

Decompression or compression of one vector entails all codebooks 153-155. Although original vector 101 does not contain centroids, decompressing compressed vector 371 would generate an uncompressed vector that consists of one centroid from each of codebooks 153-155. That uncompressed vector and original vector 101 are not identical because compression herein is lossy.

Step 406 may be caused during maintenance by a database administrator (DBA) or other technician. From a database client, step 406 receives a DDL statement (e.g. DROP statement earlier herein) that causes deleting codebooks 153-155 without deleting database column 119. For example, the processes of FIGS. 2 and 4 may occur even if database column 119 is read only or is contained in a read only table.

### 5.0 Example Statement Execution Plan

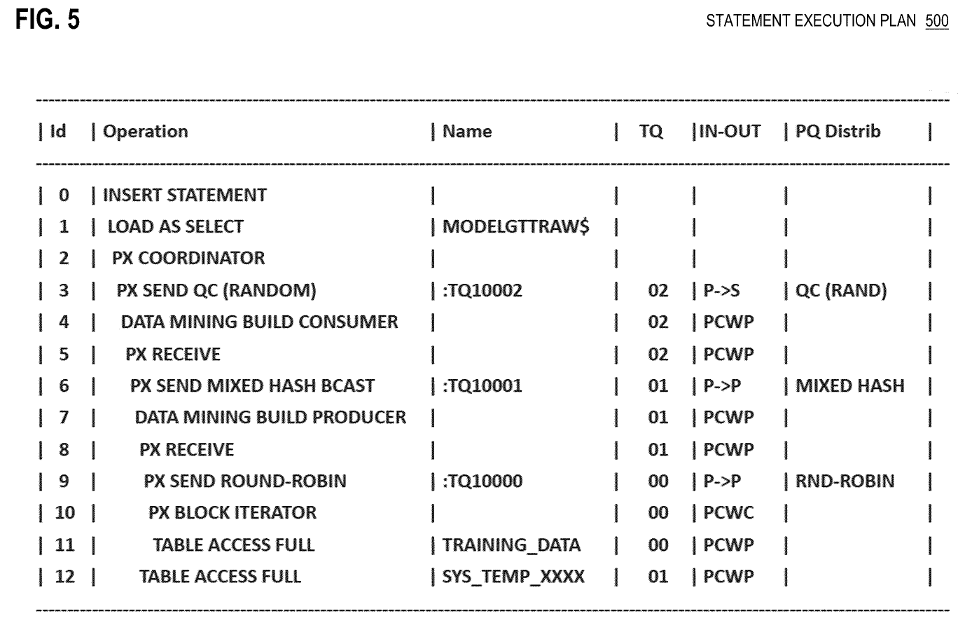

FIG. 5 depicts an example statement execution plan 500 that is a parallel execution plan for an Oracle database that performs both horizontal and vertical slicing for parallel compression as follows. Execution plans 156 and 500 are respectively for data definition language (DDL) to cause generation of codebooks 153-155 and data query language (DQL) to cause use of codebooks 153-155.

However, generation and use of codebooks are two tasks that share some common activities. For example, FIG. 3 shows dashed arrows that point to centroids 361 and 363-364 to indicate that a match of a vector slice to a nearest centroid, and that is used for: a) clustering during cluster modeling during codebook generation or b) compression. Statement execution plan 500 may be adjusted for codebook generation, vector compression, or vector decompression.

FIG. 5 implements the cluster modeling phase, after which codebooks 153-155 will be ready to use for encoding and decoding. FIG. 5 can be readily adapted to instead use existing codebooks 153-155 for uses such as retrieval augmented generation (RAG) as discussed earlier herein.

Statement execution plan 500 is shown as tabular even though statement execution plan 500 is not a database table. For demonstration, statement execution plan 500 is shown with six columns. The id column identifies steps 0-12. In other words, statement execution plan 500 has thirteen steps that operate as follows.

The operation column specifies the respective operations performed by steps 0-12. The name, temporary queue (TQ), and in-out columns qualify how each operation is performed as discussed below. For example, steps 11-12 are not identical despite having a same operation.

The operation column effectively shows a logical tree such that each operation is a node in the tree. The tree consists of a sequence of tree levels that each contain one or more tree nodes that each is a distinct step. Varied indentation shown in the operation column indicates in which level is each step. For example, steps 8 and 12 have a same indentation and thus are in a same tree level. A parent node in a previous level (i.e. less indentation) may have one or more child nodes in a next level (i.e. more indentation). For example as shown, parent step 7 has child steps 8 and 12. Step 0 is the root node and has the least indentation.

Execution of some steps is serial by design, which entails only one database server. Execution of other steps is parallel by design and entails multiple (e.g. all) database servers. Which steps are serial or parallel is shown in the operation and in-out columns in special ways as follows.

Depending on the parent and child steps, data may flow downwards from parent step to child step, upwards from child step to parent step, or both. In other words, the ordering of execution of steps 0-12 depends on dataflow direction, and parent and child steps may concurrently execute such as by pipeline parallelism. The following is an example dataflow pipeline in statement execution plan 500.

Step 11 retrieves content from database column 119. Step 9 distributes vectors to be vertically sliced. Step 7 vertically slices as discussed earlier herein. As discussed earlier herein, step 6 transfers vector slices from database column 119 to cluster models 331-333 (i.e. actually codebooks 153-155) as input. Step 4 operates codebooks 153-155 to generate compressed vectors 371-372. Step 12 creates a temporary database table. As discussed earlier herein, clustering is incremental and, for example, may occur in iterations or batches. Step 3 coordinates the iterations and distributes the k-means model for the current iteration to the producers through the SYS_TEMP XXX table. Herein, a producer or consumer is an execution context or thread as discussed earlier herein, and shuffling is an example of a many-to-many transfer from producers to consumers. Steps 0-1 store compressed vectors 371-372 into the temporary table, and that temporary table may be an implementation of a cluster. The table is temporary because, as discussed earlier herein, final centroids are retained but the clusters themselves are discarded.

In that way, running statement execution plan 500 causes generation and retention of compressed vectors 371-372. For example if the temporary table is in random access memory (RAM) for acceleration and database column 119 is on disk, then reading database column 119 is the only disk access needed for operation of all shown components in FIG. 1 in an embodiment.

Statement execution plan 500 causes parallel compression as follows. Fanout (i.e. data distribution) is when data flows from a serial step on one database server to a parallel step on multiple database servers. Fan-in is when data concurrently flows from a parallel step on multiple database servers to a serial step on one database server.

Some details shown in the operation column have the following meanings. PX SEND and PX RECEIVE operations respectively perform fanout and fan-in. Fanout causes parallel processing (i.e. acceleration).

Details shown in the in-out column have the following meanings. P→S indicates a transition from parallel data flow to serial data flow, which is fan-in. P→P indicates a shuffle, which is a transition from one parallel data distribution to another parallel data distribution.

Parallel Combine With Child (PCWC) indicates fan-in from a parallel child step into a parent step. Parallel Combine With Parent (PCWP) indicates a parallel child step ready for data from a parent step.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

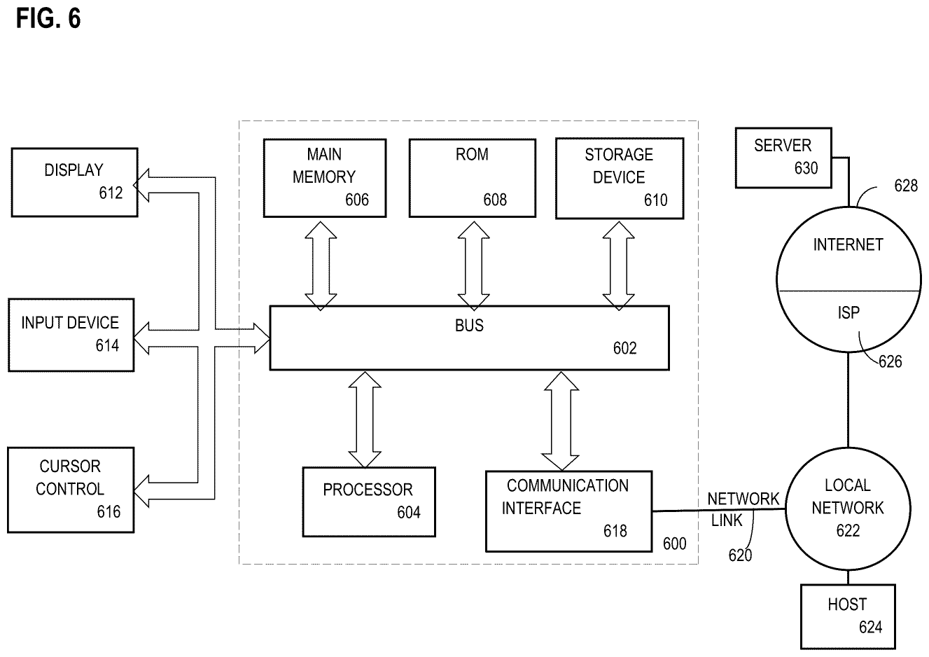

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

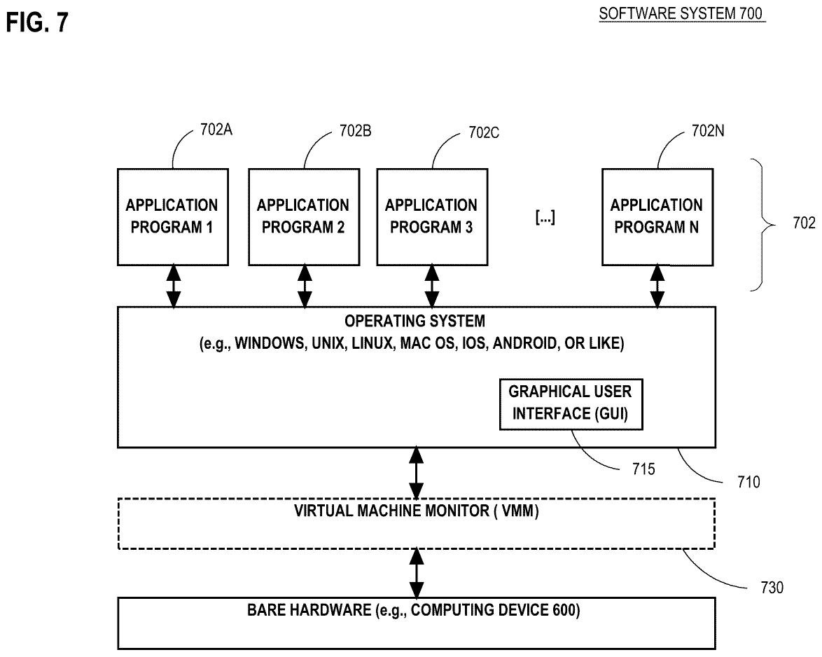

FIG. 7 is a block diagram of a basic software system 700 that may be employed for controlling the operation of computing system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computing system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C #, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L-1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27;2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
a plurality of database management system (DBMS) processes executing a database statement execution plan, said plurality of DBMS processes comprising a plurality of access processes and a plurality of generation processes, wherein executing the database statement execution plan comprises:
each access process of said plurality of access processes concurrently performing:
vertically slicing a respective subset of vectors from a database column into a plurality of vector slices, and
distributing the plurality of vector slices to the plurality of generation processes; and
each generation process of said plurality of generation processes concurrently performing:
receiving respective vector slices from the plurality of access processes, and
generating a codebook for the vector slices from the plurality of access processes;
wherein the method is performed by a plurality of computers.

2. The method of claim 1 wherein for each generation process of said plurality of generation processes, the codebook for the vector slices sent to said generation process consists of an array of centroids.

3. The method of claim 2 wherein for each generation process of said plurality of generation processes, said generating the codebook for the vector slices sent to said generation process comprises:
generating a plurality of clusters from the vector slices sent to said generation process;
generating the array of centroids in the codebook for the vector slices sent to said generation process from the plurality of clusters.

4. The method of claim 2 further comprising based on the codebooks for the vector slices sent to said plurality of generation processes, generating a compressed vector that represents a vector from the database column.

5. The method of claim 4 wherein the compressed vector that represents the vector from the database column consists of an array of integers.

6. The method of claim 5 wherein:
the array of integers contains two identical integers;
the array of centroids consists of distinct centroids.

7. The method of claim 2 further comprising based on a compressed vector that represents the vector from the database column, retrieving an other compressed vector from a vector index selected from a group consisting of: an inverted file index, an inverted file flat vector index, and a hierarchical navigable small worlds (HNSW).

8. The method of claim 7 further comprising based on the codebooks for the vector slices sent to said plurality of generation processes, decompressing the other compressed vector.

9. The method of claim 1 further comprising from a database client, receiving a database statement that causes for each generation process of said plurality of generation processes, deleting the codebooks for the vector slices sent to said plurality of generation processes.

10. The method of claim 1 wherein for each generation process of said plurality of generation processes, the respective subset of said vectors in said database column is a distinct horizontal slice of the database column.

11. One or more computer readable non-transitory media storing instructions that, when executed by one or more processors, cause:
a plurality of database management system (DBMS) processes executing a database statement execution plan, said plurality of DBMS processes comprising a plurality of access processes and a plurality of generation processes, wherein executing the database statement execution plan comprises:
each access process of said plurality of access processes concurrently performing:
vertically slicing a respective subset of vectors from a database column into a plurality of vector slices, and
distributing the plurality of vector slices to the plurality of generation processes; and
each generation process of said plurality of generation processes concurrently performing:
receiving respective vector slices from the plurality of access processes, and generating a codebook for the vector slices from the plurality of access processes.

12. The one or more computer readable non-transitory media of claim 11 wherein for each generation process of said plurality of generation processes, the codebook for the vector slices sent to said generation process consists of an array of centroids.

13. The one or more computer readable non-transitory media of claim 12 wherein for each generation process of said plurality of generation processes, said generating the codebook for the vector slices sent to said generation process comprises:
generating a plurality of clusters from the vector slices sent to said generation process;
generating the array of centroids in the codebook for the vector slices sent to said generation process from the plurality of clusters.

14. The one or more computer readable non-transitory media of claim 12 wherein the instructions further cause based on the codebooks for the vector slices sent to said plurality of generation processes, generating a compressed vector that represents a vector from the database column.

15. The one or more computer readable non-transitory media of claim 14 wherein the compressed vector that represents the vector from the database column consists of an array of integers.

16. The one or more computer readable non-transitory media of claim 15 wherein:
the array of integers contains two identical integers;
the array of centroids consists of distinct centroids.

17. The one or more computer readable non-transitory media of Claim 12 wherein the instructions further cause based on a compressed vector that represents the vector from the database column, retrieving an other compressed vector from a vector index selected from a group consisting of: an inverted file index, an inverted file flat vector index, and a hierarchical navigable small worlds (HNSW).

18. The one or more computer readable non-transitory media of claim 17 wherein the instructions further cause based on the codebooks for the vector slices sent to said plurality of generation processes, decompressing the other compressed vector.

19. The one or more computer readable non-transitory media of claim 11 wherein the instructions further cause from a database client, receiving a database statement that causes for each generation process of said plurality of generation processes, deleting the codebooks for the vector slices sent to said plurality of generation processes.

20. The one or more computer readable non-transitory media of claim 11 wherein for each generation process of said plurality of generation processes, the respective subset of said vectors in said database column is a distinct horizontal slice of the database column.
